(19) United States
(12) Patent Application Publication
(10) Pub. No.: US 2026/0308979 A1
(43) Pub. Date: Oct. 8, 2026

(54) Safety ATV Ladder

(71) Applicant: Jolene Thompson, Lumberton, TX (US)

(72) Inventor: Jolene Thompson, Lumberton, TX (US)

(21) Appl. No.: 19/098,479

(22) Filed: Apr. 2, 2025

(51) Int. Cl. E06C 7/50; E06C 1/16; E06C 7/42

(52) U.S. Cl. CPC E06C 7/505; E06C 1/16; E06C 7/423

(57) ABSTRACT

The disclosed ladder includes a pair of front base rails having a top end and a bottom end and multiple rungs there between, a pair of fly rails configured to slide within the front base rails and to extend independently from the top of the front base rails; and a pair of ratcheting contiguous hinges configured to extend from the pair of fly rails and to release based on a greater than 180 degree bending. Embodiments of the ladder include a pair of rear base rails slidably connected to the pair of front base rails between the top end and the bottom end, wherein the slidable connection is based on a hook track in the front base rails. The pair of rear base rails are further connected to the front base rails by a pair of spreaders to form an adjustable “A” frame.

### BACKGROUND

Wherever there are ladders, there is a possibility of related injury. In service and maintenance of All Terrain Vehicles ATV related injuries may be due to failure of machinery, tools, or equipment; misuse of machinery, tools, or equipment; or repetitive strain from using machinery, tools, or equipment. Most common accidents and injuries include: slips, trips, falls, muscle strain from repetitive work, being hit by falling objects, crashes, collisions, cuts and lacerations, inhaling toxic fumes, exposure to loud noise and walking into objects. It is probable that by following safety precautions and procedures many of these injury incidents could be avoided.

A common tool used in the service, maintenance and repair of ATV is a ladder. A ladder is a vertical or inclined set of rungs or steps. There are two types of ladders: self-supporting ladders that are placed on the ground and rollable ladders made of rope or other material that are hung down from the top of something. A ladder may be fixed onto a specific place such as a building, structure, or equipment or the ladder may be rigid and portable. The most common injury sustained by a person using a ladder is bruising from falling off a ladder, but bone fractures are common and head injuries are also likely, depending on the nature of the accident. Ladders can slip backwards owing to faulty base pads or improper leaning ladder angle.

There exists a need for a Safety ATV Ladder that is not being met by any known or disclosed device or system of present.

### SUMMARY OF THE INVENTION

The disclosed ladder includes a pair of front base rails having a top end and a bottom end and multiple rungs there between, a pair of fly rails configured to slide within the front base rails and to extend independently from the top of the front base rails; and a pair of ratcheting contiguous hinges configured to extend from the pair of fly rails and to release based on a greater than 180 degree bending.

Embodiments of the ladder include a pair of rear base rails slidably connected to the pair of front base rails between the top end and the bottom end, wherein the slidable connection is based on a hook track in the front base rails. The pair of rear base rails are further connected to the front base rails by a pair of spreaders to form an adjustable “A” frame.

### BRIEF DESCRIPTION OF THE DRAWINGS

FIG. 1 is a depiction of the perspective view of the safety ladder in accordance with an embodiment of the present disclosure.

FIG. 2 depicts a redundancy fail safe for the safety ladder in accordance with an embodiment of the disclosure.

FIG. 3 depicts a greater than 180 degree bend in the ratcheting contiguous hinges in accordance with an embodiment of the disclosure.

FIG. 4 depicts the pair of rear base rails connection to the pair of front base rails in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

The term “safety” refers to elements or features that are meant to reduce the risk of property damage, accident, and personal injury due to accidental or intentional misuse of the ladder. The term “top cap” is used to refer to the top horizontal and corresponding vertical sides of the ladder above the top rung or step.

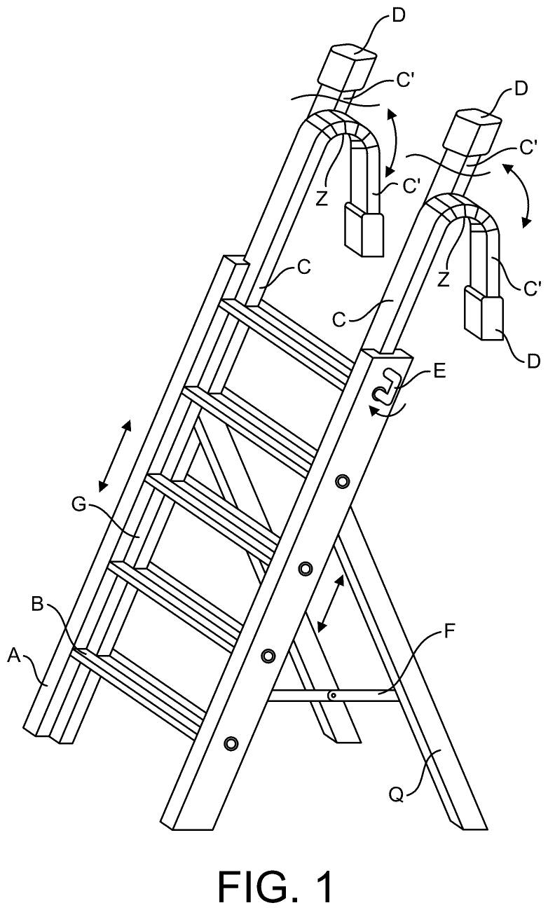

FIG. 1 is a depiction of the perspective view of the safety ladder in accordance with an embodiment of the present disclosure. The depiction includes the pair of base front rails A, the rungs B which are of a no-slip construction, the pair of fly rails C which slide through the pair of base front rails, the non-scratching end caps D on the ends of the pair of fly rails, the locking hook E on the right side of the base front rails (and a locking hook on the left side of the base front rails not depicted), spreaders F also known as a foldable bracket support the base front rails A to the base back rails Q. Reference G depicts how the pair of flying rails slide through the pair of front base rails. Reference C′ depicts the pair of slide rails on the other side of the ratcheting contiguous hinges Z that are bendable from a straight on parallel with the pair of front base rails and bendable to greater than 180 degrees therefrom to act as a pair of hooks on the pair of fly rails. The ratcheting contiguous hinges release at greater than 180 degrees bend and on a straight with the pair of base front rails and the pair of fly rails but cannot bend in the other direction away from a lean of the ladder into an RV or into another structure. The straight pair of fly rails are bent straight from the curved position shown by the arrows proximal the pair of fly rails C, Z and C′.

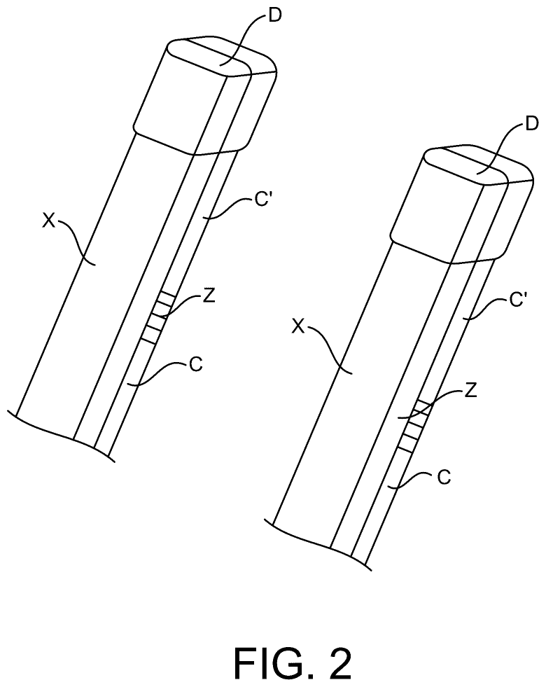

FIG. 2 depicts a redundancy fail safe for the safety ladder in accordance with an embodiment of the disclosure. The present depiction is a fail safe to a fail of the ratcheting contiguous hinges. In other words, a redundant pair of fly rail runs X parallel to the fly rail C, Z and C′ ensures there is not a greater than a zero degree straightening of the ratcheting contiguous rails Z. The redundant rail also slides through the front base rails (not depicted). The non scratching end caps D cover both the redundant pair of fly rails X and the fly rails C, C′.

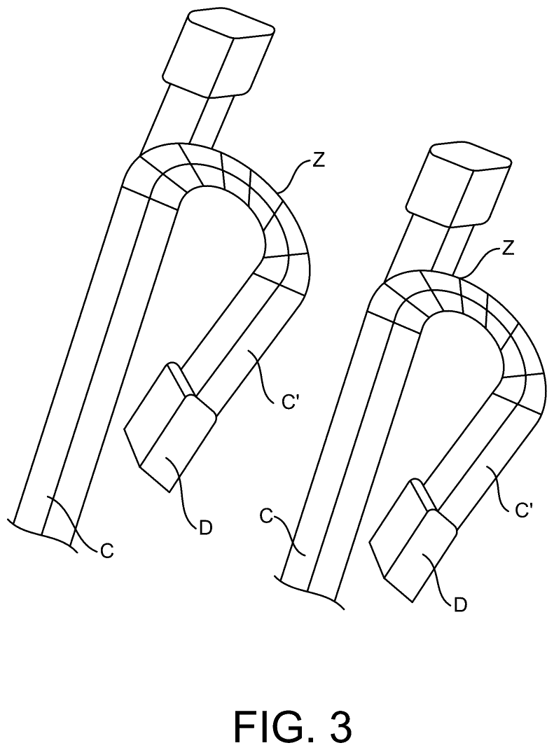

FIG. 3 depicts a greater than 180 degree bend in the ratcheting contiguous hinges in accordance with an embodiment of the disclosure. The ratcheting contiguous hinges Z are bent at an angle greater than 180 degrees in order to release the ratchet in the contiguous hinges which is also released when the ratcheting contiguous hinges are bent straight or parallel with the base front rails A.

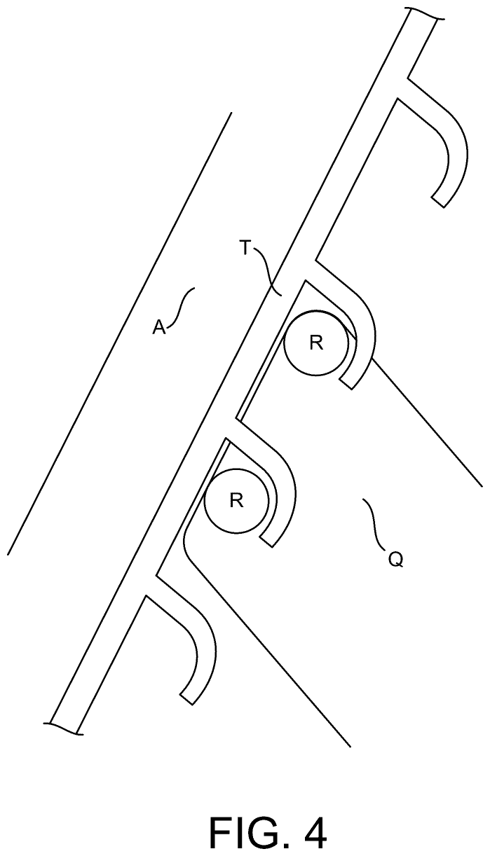

FIG. 4 depicts the pair of rear base rails connection to the pair of front base rails in accordance with an embodiment of the present disclosure. The pair of rear base rails Q connect at the pair of front base rails at respective ends through circular bosses R, also known as rod ends which engage with hooks T in the pair of base front rails A. The pair of rear base rails Q and respective bosses R lock into place as the ladder leans with gravity forcing the bosses/rod ends R into the T hooks and adjust in height when engaged with lower and higher placements of bosses/rod ends R. This enables a varying lean angle against an ATV or against another structure.

Embodiments further include triggering the plurality of audio and visual alarms including a beeping audio speaker and a green light visual alarm and a red light respectively via the motion sensor located just above the bottom rung and just above the top rung below the top cap of the ladder. Embodiments yet include sensing the change of rate of a level of the ladder via a capacitance of a fluid in the plurality of level sensors at a predetermined point in the plurality of level sensors and via a laser through a fluid in the plurality of level sensors at a predetermined point in the plurality of level sensors.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A ladder comprising:
a pair of front base rails having a top end and a bottom end and multiple rungs there between; a pair of fly rails configured to slide within the front base rails and to extend independently from the top of the front base rails; and
a pair of ratcheting contiguous hinges configured to extend from the pair of fly rails and to release based on a greater than 180 degree bending.

2. The ladder of claim 1, further comprising a pair of rear base rails slidably connected to the pair of front base rails between the top end and the bottom end.

3. The ladder of claim 2, wherein the slidable connection is based on a hook track in the front base rails.

4. The ladder of claim 2, wherein the pair of rear base rails each comprise a rectangular cross section.

5. The ladder of claim 2, wherein the pair of rear base rails are further connected to the front base rails by a pair of spreaders to form an adjustable “A” frame.

6. The ladder of claim 1, wherein the pair of ratcheting and continuous hinges also release based on a zero degree/straight bending.

7. The ladder of claim 1, wherein the pair of front base rails and the pair of fly rails each comprise a rectangular cross section.

8. The ladder of claim 1, further comprising a left height locking hook and a right height locking hook configured to fix the pair of fly rails in relation to the pair of front base rails.

9. The ladder of claim 1, wherein a left fly rail of the pair of fly rails extends independently of a right fly rail of the pair of fly rails.

10. The ladder of claim 1, wherein the left fly rail of the pair of fly rails extends and locks independently of a right fly rail of the pair of fly rails by a respective height locking hook.

11. The ladder of claim 1, wherein the pair of fly rails hook onto a rung of another ladder based on the bending of the pair of ratcheting contiguous hinges.

12. The ladder of claim 1, wherein the pair of fly rails hook onto a roof of a recreational vehicle based on the bending of the pair of ratcheting contiguous hinges.

13. The ladder of claim 1, wherein the pair of ratcheting contiguous hinges are disposed proximal a top of the pair of fly rails.

14. The ladder of claim 1, further comprising an extension of the pair of front base rails parallel to the pair of ratcheting contiguous hinges to provide a safety fail safe.

15. The ladder of claim 1, further comprising a pair of ratcheting contiguous hinges configured to extend from the top end of the pair of front base rails.

16. The ladder of claim 1, further comprising a non-scratching end-cap on each end of the pair of fly rails and the pair of front base rails.
